(19) United States
(12) Patent Application Publication
(10) Pub. No.: US 2014/0217302 A1
(43) Pub. Date: Aug. 7, 2014

(54) Matrix of Pixels with Programmable Clusters

(71) Applicants: COMMISSARIAT A L'ENERGIE ATOMIQUE ET AUX ENERGIES ALTERNATIVES, Paris (FR); TRIXELL, Moirans (FR)

(72) Inventor: Marc Arques, Grenoble (FR)

(73) Assignees: COMMISSARIAT A'LENERGIE ATOMIQUE ET AUX ENGERGIES ALTERNATIVES, Bâtiment Le Ponant D (FR); TRIXELL, Moirans (FR)

(21) Appl. No.: 14/130,304

(22) PCT Filed: Jun. 29, 2012
(86) PCT No.: PCT/EP2012/062737

§ 371 Date: Mar. 11, 2014

(30) Foreign Application Priority Data
Jun. 30, 2011 (FR) 1102063

(51) Int. Cl. G01T 1/17

(52) U.S. Cl. CPC G01T 1/17
USPC 250/394

(57) ABSTRACT

An imaging device comprising a matrix (10; 20; 30) of pixels (P(i,j); Q(i,j); R(i,j); X(i,j); Y(i,j)) organized in rows and columns, and a method for implementing said device. Each current pixel (P(i,j); Q(i,j); R(i,j); X(i,j); Y(i,j)) comprises: a row grouping switch (B(i,j)) making it possible to group the current pixel (P(i,j); Q(i,j); R(i,j); X(i,j); Y(i,j)) with the following pixel (P(i,j+1); Q(i,j+1); R(i,j+1); X(i,j+1); Y(i,j+1)) of the same row; a column grouping switch (A(i,j)) making it possible to group the current pixel (P(i,j); Q(i,j); R(i,j); X(i,j); Y(i,j)) with the following pixel (P(i+1,j); Q(i+1,j); R(i+1,j); X(i+1,j); Y(i+1,j)) of the same column; and storage means (M(i,j); U(i,j); V(i,j)) making it possible to define the state, on or off, of the two grouping switches (A(i,j), B(i,j)).

The invention relates to an imaging device and a method implementing the device. The invention can be implemented for imaging in a detector. This type of device comprises a large number of sensitive points called pixels, generally organized in a matrix or in a strip.

The invention is useful in producing visible images but is not limited to this field. In the context of the invention, the term imaging should be understood in a wide sense. It may be possible, for example, to produce mappings of pressure or of temperature or even two-dimensional representations of chemical or electrical potentials. These mappings or representations form images of physical quantities.

In a detector, a pixel represents the basic sensitive element of the detector. Each pixel converts a physical phenomenon to which it is subjected into an electrical signal. The electrical signals obtained from the different pixels are collected in a matrix reading phase then digitized so as to be able to be processed and stored to form an image. The pixels are formed from an area that is sensitive to the physical phenomenon and delivers a current of electrical charges. The physical phenomenon may be an electromagnetic radiation and, consequently, the invention will be explained by means of this type of radiation and the charge current is a function of the photon stream received by the sensitive area. Generalization to any imaging device will be easy.

The photosensitive area generally comprises a photosensitive element, or photodetector, which can, for example, be a photodiode, a photoresistor or a phototransistor. There are photosensitive matrices of large dimensions which can have several million pixels. Each pixel is made up of a photosensitive element and an electronic circuit consisting, for example, of switches, capacitors, resistors, downstream of which there is an actuator. The assembly made up of the photosensitive element and the electronic circuit makes it possible to generate electrical charges and collect them. The electronic circuit generally makes it possible to reset the charge collected in each pixel after a charge transfer. The role of the actuator is to transfer or copy the charges collected by the circuit in a read electrode. This transfer is performed when the actuator receives the instruction. The output of the actuator corresponds to the output of the pixel.

In this type of detector, a pixel operates according to two phases: an imaging phase, during which the electronic circuit of the pixel accumulates the electrical charges generated by the photosensitive element, and a reading phase, during which the collected charges are transferred or copied into the read electrode, by virtue of the actuator.

During the imaging phase, the actuator is passive and the electrical charges collected change the potential at a point of connection between the photosensitive element and the actuator. This point of connection is called pixel charge collection node or, more simply, pixel node. During the reading phase, the actuator is active in order to release the charges accumulated at the photosensitive point in order to convey them or copy them, even to copy the potential of the node of the pixel to a reading circuit of the detector positioned downstream of the actuator.

A passive actuator should be understood to be an actuator that is not in electrical contact with the reading circuit. Thus, when the actuator is passive, the charges collected in the pixel are neither transferred nor copied into the reading circuit.

An actuator can be a switch controlled by a clock signal. It is generally a transistor. It can also be a follower circuit or any other device making it possible to refer or transfer the charge collected in the pixel to the reading circuit, for example a device known by the acronym CTIA (Capacitive TransImpedance Amplifier).

This type of pixel can be used for imaging of ionizing radiations, and notably the detectors of X or γ radiations, in the medical field or in the field of non-destructive inspection in the industrial field, for the detection of radiological images. In some detectors, the photosensitive elements make it possible to detect a visible or near-visible electromagnetic radiation. These elements have little or no sensitivity to the radiation incident to the detector that is to be detected. A radiation converter, called a scintillator, is then used to convert the radiation incident, for example an X radiation, into a radiation in a band of wavelengths to which the photosensitive elements present in the pixels are sensitive.

According to another type of detector, increasingly widely used, the detector material is a semiconductor, sensitive to the radiation, for example X or gamma, to be detected. An interaction of a radiation in the detector generates charge carriers. The charges generated by an interaction are collected at a terminal, called node of the pixel.

During the imaging phase, the electromagnetic radiation, in the form of photons received by each photosensitive element, is converted into electrical charges (electron/hole pairs) and each pixel generally comprises a capacitor making it possible to accumulate these changes in order to make the voltage of the node of the pixel change. This capacitance can be intrinsic to the photosensitive element, in which case it is called stray capacitance, or added in the form of a capacitor connected in parallel to the photosensitive element.

Generally, the pixels are read individually. The matrix may, for example, comprise a read electrode associated with each column of pixels of the matrix. In this case, a read instruction is sent to all the actuators of one and the same row of the matrix and each of the pixels of this row is read by transferring its electrical information, charge, voltage, current, frequency, etc., to the read electrode with which it is associated.

It may be necessary to group together a number of pixels to read them collectively. This grouping can be useful in order to increase the matrix reading speed or even to improve the signal-to-noise ratio of each element read. The grouped pixels may have means for carrying out the operations of summing or averaging the electrical information from the grouped pixels. These means may be analog or digital.

Hereinbelow, the case will be described in which the electrical information is available in analog form in the pixels, in the form of quantities of charges stored on capacitors of the same value. Obviously, the invention can be implemented for any form of electrical information generated in each of the pixels.

Matrices have already been produced that provide for adjacent pixels to be grouped in fours or in eights. The means for carrying out the averaging operation is simply a grouping switch connecting the capacitors of adjacent pixels. The switches are controlled by row or column electrodes of the matrix, setting the on- or off-state of each switch. In order to limit the number of electrodes, the possible groups are predetermined. One electrode can set the state of several switches. For example, a set of electrodes arranged on every other row makes it possible to group all the pixels of the matrix in pairs. To produce groupings in fours, it is necessary to add other grouping switch control electrodes making it possible to group two adjacent pairs.

As soon as there is a desire to multiply the possible grouping configurations, the number of electrodes increases, which complicates the routing of the matrix and reduces the space available for the photosensitive elements. It is almost impossible to produce variable groupings, which would require the implementation of one electrode per grouping switch.

This type of implementation also presents a limitation when certain pixels are defective, which can frequently be the case in matrices comprising a large number of pixels. It may, for example, be a very noisy pixel or a pixel short-circuited with a power supply. The false or missing information from this pixel is then replaced by the average of the information items from its neighbors. However, if this defective pixel pollutes or destroys a group of pixels, its acceptance becomes much more difficult, all the more so if the pollution or destruction extends to larger groups.

The invention aims to mitigate all or some of the problems cited above by proposing a matrix of pixels in which grouping switches are programmable.

To this end, the subject of the invention is an imaging device comprising a matrix of pixels organized in rows and columns, characterized in that each current pixel of the matrix comprises:
a row grouping switch making it possible to group the current pixel with the following pixel of the same row, if the following pixel exists in the row to which the current pixel belongs,
a column grouping switch making it possible to group the current pixel with the following pixel of the same column, if the following pixel exists in the column to which the current pixel belongs, and
storage means making it possible to define the state, on or off, of the two grouping switches.

The invention will be better understood and other advantages will become apparent on reading the detailed description of an embodiment given by way of example, the description being illustrated by the appended drawings in which:

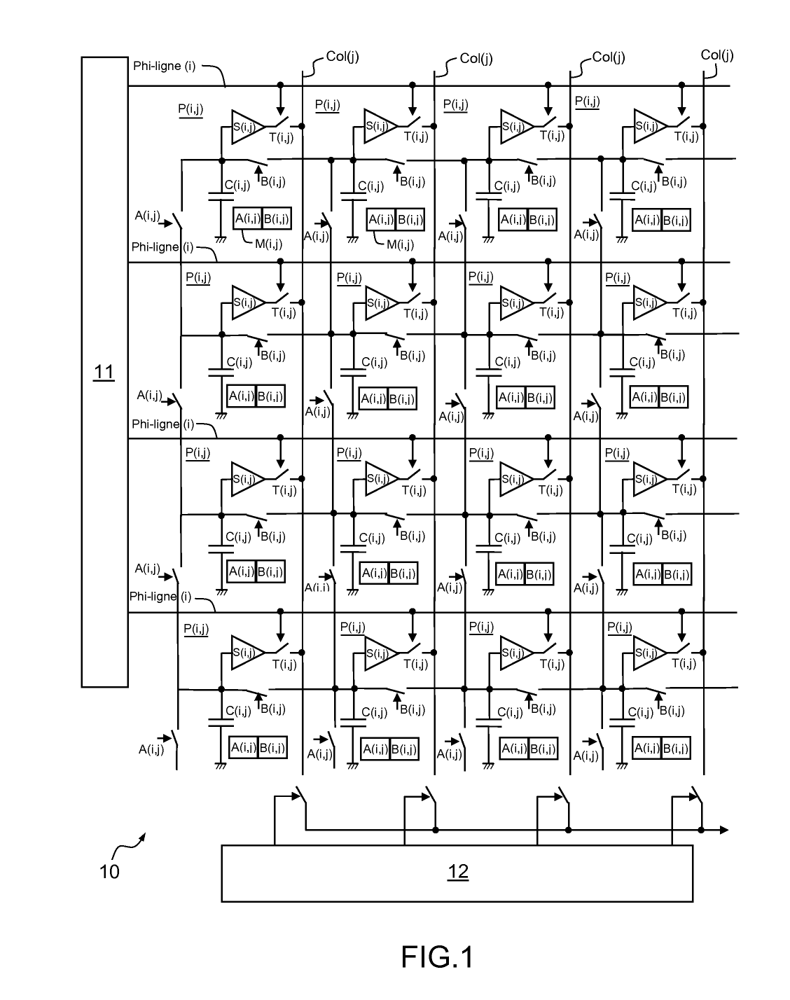

FIG. 1 represents an example of a matrix of pixels according to the invention, in which the electrical information collected from the reading of each of the pixels is a voltage;

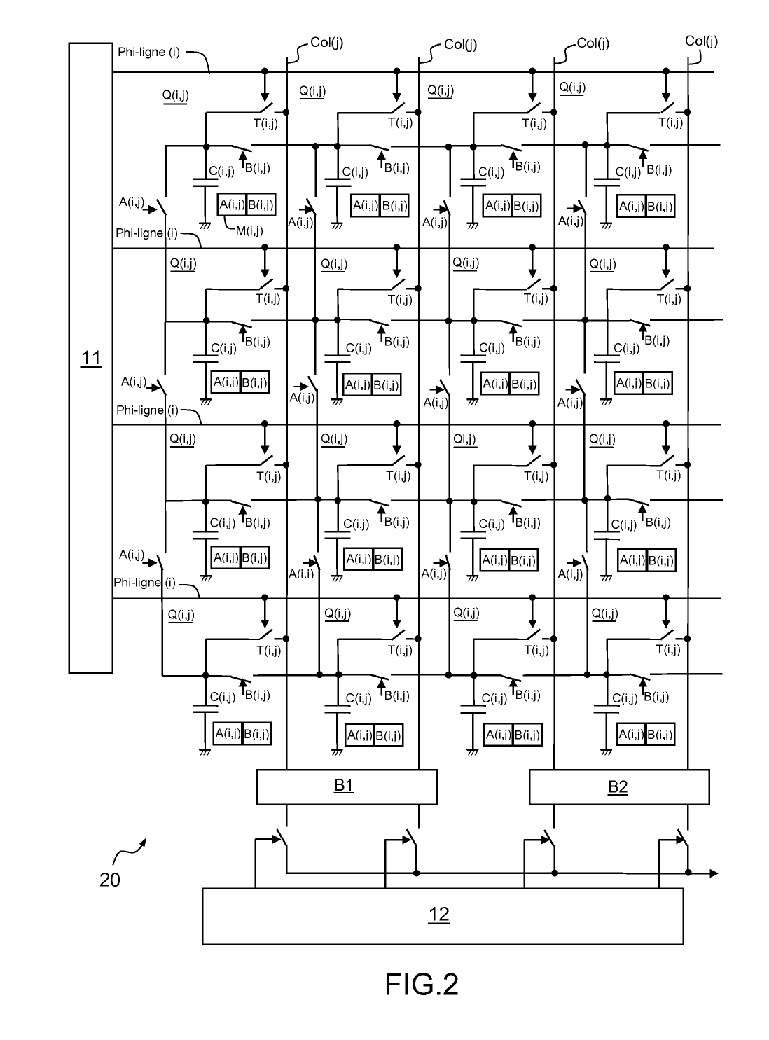

FIG. 2 represents another example of a matrix of pixels according to the invention, in which the electrical information collected from the reading of each of the pixels is a charge;

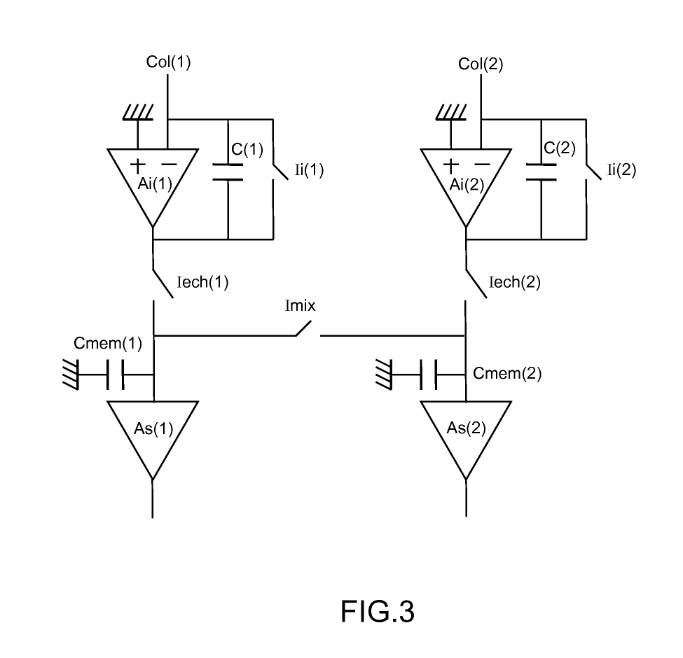

FIG. 3 represents an example of means for adding or averaging the charges transiting in different column electrodes of the matrix of FIG. 2;

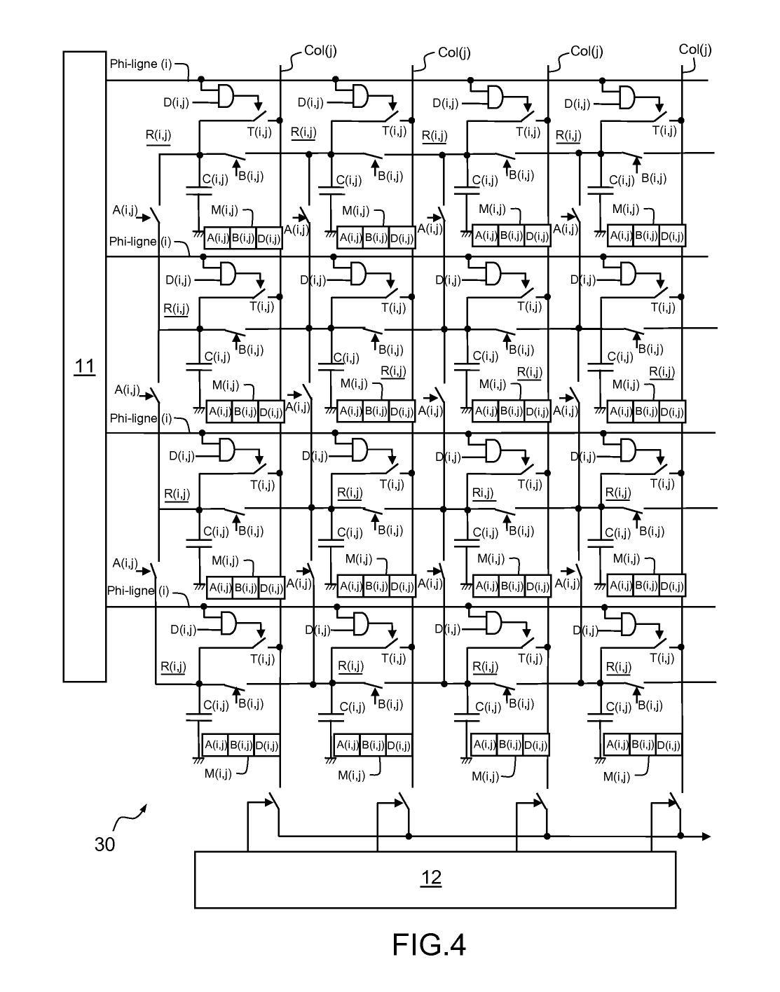

FIG. 4 represents a variant of the matrix of FIG. 2;

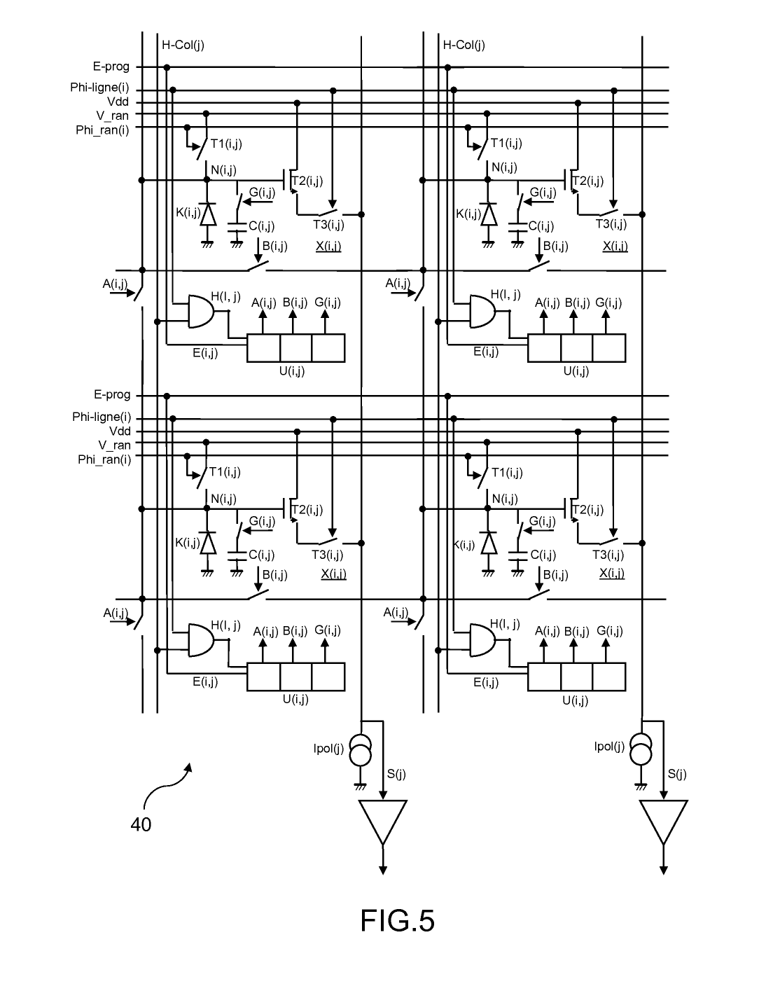

FIG. 5 represents an example of a matrix according to the invention in which the pixels comprise a shift register;

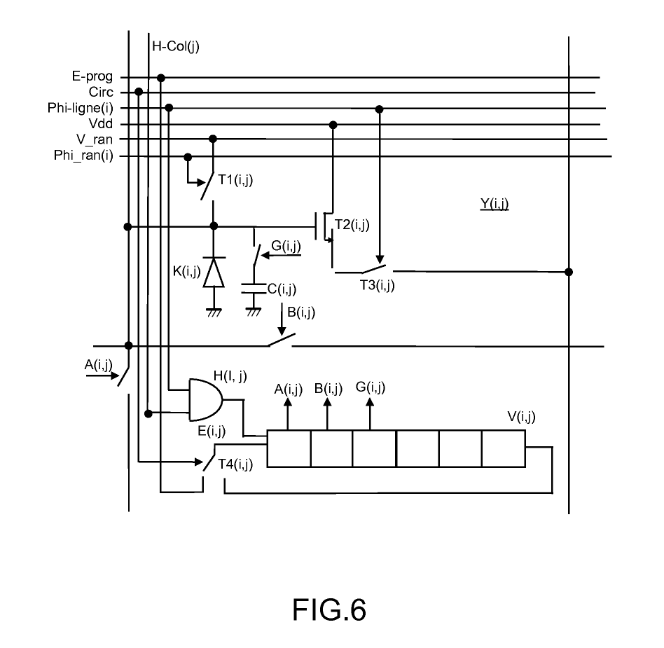

FIG. 6 represents another example of a pixel comprising a shift register;

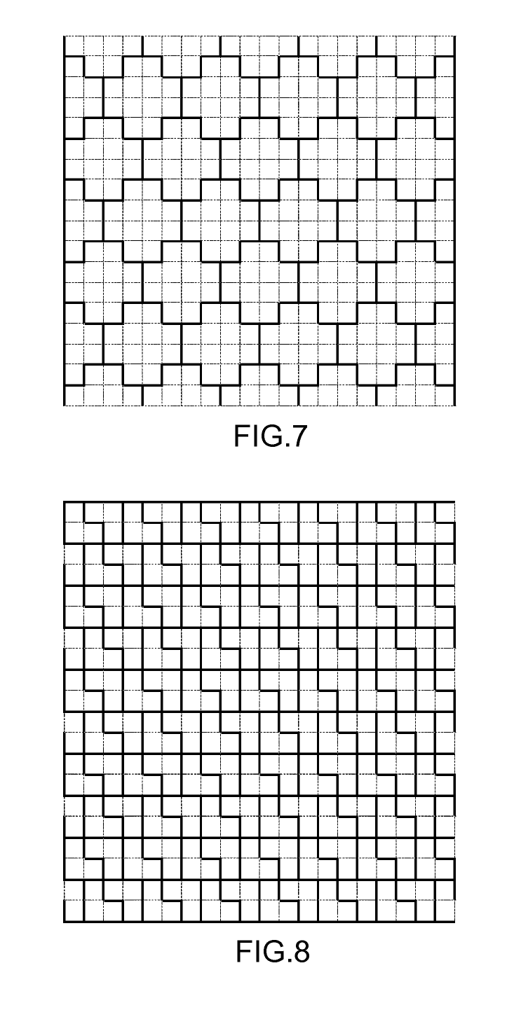

FIGS. 7, 8 and 9 represent several examples of groupings of pixels.

In the interests of clarity, the same elements bear the same references in the different figures.

FIG. 1 represents a matrix 10 comprising sixteen pixels P(i,j) distributed in four rows and four columns. In this figure, the rows and the columns are identified by their rank, i for the rows and j for the columns. The pixels P(i,j) are advantageously all identical, which simplifies the production of the matrix. Obviously, the invention is not limited to a matrix of this size. There are often matrices that have a much greater number of pixels and in which the invention can be implemented.

Each pixel P(i,j) comprises an element sensitive to a physical phenomenon, such as, for example, an electromagnetic radiation. This phenomenon is, in the example represented, converted into electrical charges. The sensitive element is represented in FIG. 1 in a simplified manner by a capacitor C(i,j) making it possible to accumulate the electrical charges obtained from the conversion of the physical phenomenon. As seen previously, in the example of an electromagnetic radiation to be quantified, the sensitive element can be a photodiode and the capacitor C(i,j) represents its stray capacitance, or possibly an additional capacitance connected in parallel with the photodiode, on which the electrical charges obtained from the conversion of the radiation accumulate. A first electrode of the capacitor C(i,j) is connected to a ground of the matrix 10. The potential of the second electrode of the capacitor C(i,j) changes as a function of the accumulated electrical charges. This second electrode forms the node of the pixel. As stated above, the physical phenomenon can be transformed by the sensitive element into other types of electrical information such as, for example, a voltage, a current or a frequency.

In the example of FIG. 1, each pixel P(i,j) comprises a voltage follower S(i,j) making it possible to copy at the output of the pixel, the voltage corresponding to the charges accumulated in the capacitor C(i,j) and an actuator T(i,j) making it possible to transfer, during a reading phase, the voltage supplied by the follower S(i,j) to a column electrode Col(j) of the matrix 10. The actuator T(i,j) is controlled by an row electrode Phi-ligne(i) of the matrix 10. The follower S(i,j) is connected at its input to the node of the pixel P(i,j).

The matrix 10 also comprises a row addressing register 11 for driving the different electrodes in row Phi-ligne(i) of the matrix 10 and a column read register 12 for collecting the voltages present on the different electrodes in column Col(j) when the actuators T(i,j) are on.

Each pixel P(i,j) comprises a row grouping switch B(i,j) making it possible to group it with the pixel P(i,j+1) of the same row situated in the next column and a column grouping switch A(i,j) making it possible to group it with the pixel P(i+1,j) of the same column situated in the next row.

The grouping switches A(i,j) and B(i,j) make it possible to connect the capacitors C(i,j) of the different pixels P(i,j) concerned at the node of each of the pixels P(i,j).

As seen previously, the pixels P(i,j) are advantageously all identical in order to simplify the definition of the masks for producing the matrix. Given this assumption, even the pixels of the last row comprise the row grouping switch B(i,j). Similarly, the pixels of the last column comprise the column grouping switch A(i,j). These switches are unnecessary and are simply not connected to the next pixel since it does not exist.

Each pixel P(i,j) also comprises storage means M(i,j) making it possible to define the state, on or off, of the two grouping switches A(i,j) and B(i,j). More specifically, the storage means M(i,j) comprise two binary storage locations in each of which the state of one of the switches A(i,j) and B(i,j) is stored. Each storage location comprises, for example, a flip-flop. The grouping switches A(i,j) and B(i,j) are, for example, field-effect transistors driven by their gate and an output of each of the storage locations drives the gate of the associated switch. To this end, in FIG. 1, in each of the storage locations, the identifier of the associated grouping switch A(i,j) or B(i,j) has been marked.

Access to the storage means M(i,j) for storing the necessary information therein is not represented in FIG. 1 to keep it uncluttered. The addressing can be done by means of row and column electrodes making it possible to identify the addressed pixel P(i,j). Each pixel P(i,j) can comprise an AND cell, of which two inputs are respectively connected to the addressing row electrode and column electrode. The output of the AND cell therefore defines the pixel to be programmed. An additional electrode, which may be routed either in line or in column, makes it possible to convey the datum to be stored to each of the storage locations. There is therefore a data electrode for each storage location and common to all the pixels P(i,j). The addressing and data electrodes are driven by the registers 11 and 12.

The grouping of several neighboring pixels P(i,j) is produced by connecting the different capacitors C(i,j) of the pixels of the grouping at their respective nodes. This connection averages the potentials of these different pixel nodes P(i,j) of the grouping. The voltages available at the output of the different followers S(i,j) of the grouping are therefore equal and, in the reading phase of the matrix 10, any one of the voltage followers S(i,j) of the grouping can be chosen to connect it to the column electrode Col(j) by means of the actuator T(i,j) associated with the voltage follower S(i,j) of the pixel P(i,j) retained.

Take, for example, the case where four neighboring pixels are to be grouped together to form a square pattern spread over two rows 2i and 2i+1 and two columns 2j and 2j+1. For any current value of i and j, the storage means M(i,j) are programmed to group the pixels of coordinates: (2i,2j); (2i+1,2j); (2i+1,2j) and (2i+1,2j+1). In the reading phase, the row addressing register 11 drives the actuators associated with the electrodes in row Phi-ligne(2i) and the column read register 12 drives the electrodes in column Col(2j). The pixels P(2i, 2j) therefore represent the group to which they belong.

Assuming that a pixel of coordinates other than (2i, 2j) is defective, the grouping switches A(i,j) and B(i,j) are programmed so that it does not belong to any group. It is therefore not read, and does not pollute the group to which it would have belonged if the groupings had been systematic. There is now simply a group of three pixels instead of four.

If, on the other hand, a pixel of coordinates (2i, 2j) is defective, as previously, the grouping switches are programmed so that it does not belong to any group. However, in order to read the other pixels of this group, it is necessary in this case to also modify the programming of the column read register 12 so that, when the row electrode Phi-ligne(2i) is addressed, instead of addressing the column electrode Col(2j), the column electrode Col(2j+1) is addressed.

It may be that several pixels are defective. Assuming that two pixels of coordinates (2i, 2j) and (2i, 2j+1) are defective, the grouping switches A(i,j) and B(i,j) are programmed so that the defective pixels do not belong to any group so as not to pollute the group to which they would have belonged if the groupings had been systematic. In order to read the other pixels of this group, it is essential in this case to also modify the programming of the row addressing register 11 so that the row electrode Phi-ligne(2i+1) is addressed instead of the row electrode Phi-ligne(2i).

However, the solution of the preceding paragraph no longer works if, on a pair of rows 2i, 2i+1, there are both pairs of defective pixels of coordinates (2i, 2j), (2i, 2j+1) and pairs of defective pixels of coordinates (2i+1, 2k), (2i+1, 2k+1). In this case, to read the two groups that have defective pairs, the rows 2i and 2i+1 must be addressed in succession.

More generally, if all the pixels are good, in the reading phase, the addressing is done via the rows 2i.

If a few rare pixels are defective, the addressing can take this into account and shift by one rank the rows or the columns to which the defective pixels belong.

If the number of pairs of defective pixels increases, the 2 rows or the 2 columns corresponding to the groups must in some cases be read. This therefore slows down the reading speed. A benefit is nevertheless retained by improving the signal-to-noise ratio of the voltages read.

If the number of pairs of defective pixels increases further, the trend is toward an addressing of all the rows and of all the columns. The benefit of the groupings in terms of reading speed disappears completely. The benefit concerning the signal-to-noise ratio does however remain. This case is nevertheless improbable in an industrially produced imaging device.

FIG. 2 represents a matrix 20 comprising, as previously, sixteen pixels Q(i,j) distributed in four rows and four columns. In each pixel Q(i,j), there are the capacitor C(i,j) for accumulating the electrical charges deriving from the conversion of the physical phenomenon, the actuator T(i,j), the grouping switches A(i,j) and B(i,j) and the storage means M(i,j) associated with the grouping switches A(i,j) and B(i,j). In the matrix 20, there are the electrodes in column Col(j) and in row Phi-ligne(i), the row addressing register 11 and the column read register 12.

Unlike the matrix 10, the matrix 20 does not include any follower and the node of the pixel Q(i,j) can be directly connected to the column electrode Col(j) through the actuator T(i,j).

In the reading phase, the charges accumulated at the node of each pixel Q(i,j) are transferred to the electrodes in column Col(j), through the actuator T(i,j), when the pixel Q(i,j) is addressed by the row electrode Phi-ligne(i). Note that, in the matrix 20, the reading of the information of a pixel Q(i,j) is destructive to the information. In other words, after the transfer of the charges from the node of a pixel Q(i,j) to the associated column electrode Col(j), the charges are no longer available on the node of the pixel Q(i,j).

When a choice is made to group pixels by means of the grouping switches A(i,j) and/or B(i,j), the potentials of the different nodes connected are averaged and the charges are added together. When a group is read, the actuators T(i,j) can be driven so that a single actuator T(i,j) is closed in one and the same grouping. The charges added up by the selected actuator T(i,j) are then recovered. However, this requires the actuators T(i,j) to be driven individually and therefore a system for addressing the row and column actuators T(i,j), which greatly increases the routing of the matrix 20. It is easier to drive the actuators T(i,j) per row by means of the electrodes in row Phi-ligne(i). In this case, if a group is spread over several consecutive columns, the charges of the group can simultaneously be evacuated to column electrodes through several actuators T(i,j) and therefore several electrodes in column Col(j). It is therefore useful for the matrix 20 to comprise reading means, to add or average the charges passing through the different column electrodes associated with one and the same grouping.

An example of such means is represented in FIG. 2 by the blocks B1 and B2 situated at the end of the column electrodes. Each of the blocks makes it possible to produce an average of the electrical signals conveyed by two electrodes in column Col(j). A more detailed diagram of one of these blocks is offered in FIG. 3.

In this block, two electrodes in column Col(1) and Col(2) are connected respectively to the inverting input of two integrator amplifiers Ai(1) and Ai(2). The non-inverting inputs of the two integrator amplifiers Ai(1) and Ai(2) are connected to the ground of the matrix 20. A capacitor, respectively C(1) and C(2), as well as a switch, respectively Ii(1) and Ii(2), are connected in parallel between the inverting input and the output of each of the integrator amplifiers Ai(1) and Ai(2).

The charges received on the electrodes in column Col(1) and Col(2) are transformed into voltage on each of the capacitors C(1) and C(2). The switches Ii(1) and Ii(2) are driven to reset to zero the difference in potentials between the electrodes of the capacitors C(1) and C(2).

Capacitors, respectively Cmem(1) and Cmem(2), are connected between the output of each integrator amplifier Ai(1) and Ai(2) and the ground of the matrix 20 via switches Iech(1) and Iech(2). The output voltages of these amplifiers are stored, on the capacitors, respectively Cmem(1) and Cmem(2).

A mixing switch Imelange makes it possible to connect the active electrodes (not linked to the ground) of the two capacitors Cmem(1) and Cmem(2). The switch Imelange makes it possible to average the voltages present on each of the two capacitors Cmem(1) and Cmem(2) when it is closed.

The voltage present at the terminals of each of the capacitors Cmem(1) and Cmem(2), possibly averaged when the switch Imel is closed, is then read by means of follower amplifiers respectively As(1) and As(2).

The block B1 represented in FIG. 3 makes it possible to average the electrical information available on the two electrodes in column Col(1) and Col(2). It is obviously possible to generalize the mixing switches between all the consecutive electrodes in column Col(i). The mixing switches will be operated according to the definition of the pixel groupings Q(i,j) of the matrix 20.

FIG. 4 represents a matrix 30 forming a variant embodiment of the matrix 20 in which the actuators T(i,j) can be driven individually without in any way requiring an individual addressing by means of electrodes dedicated to this addressing.

FIG. 4 represents a matrix 30 comprising, as previously, sixteen pixels R(i,j) distributed in four rows and four columns. In each pixel R(i,j), there are the capacitor C(i,j) making it possible to accumulate the electrical charges deriving from the conversion of the physical phenomenon, the actuator T(i,j) and the grouping switches A(i,j) and B(i,j). In the matrix 30, there are the electrodes in column Col(j) and in row Phi-ligne(i), the row addressing register 11 and the column read register 12. The node of the pixel R(i,j) is directly connected to the actuator T(i,j) without follower.

Each of the pixels R(i,j) also comprises storage means M(i,j) associated with the grouping switches A(i,j) and B(i,j). Unlike the matrices 10 and 20, the storage means M(i,j) of the matrix 30 make it possible to also authorize the closure of the actuator T(i,j). More specifically, the storage means M(i,j) comprise an additional binary storage location, in which an authorization to close the actuator T(i,j) is stored.

The authorization to close the actuator T(i,j) is made in conjunction with a command to read the pixel R(i,j). More specifically, the actuator T(i,j) is still controlled by means of the row electrode Phi-ligne(i). This command can be disabled according to the datum stored in the additional location of the storage means M(i,j). In practice, the pixel R(i,j) may comprise an AND cell of which a first input is connected to the row electrode Phi-ligne(i) and of which a second input is connected to the additional location whose datum is denoted D(i,j). The output of the AND cell forms the gate command of the actuator T(i,j).

It has been seen previously that the programming of the storage locations can be done by means of an electrode dedicated to each of the storage locations, complementing the electrodes necessary for the addressing of the pixels. The increase in the number of storage locations therefore complicates the production of the matrix 30 by imposing the routing of the additional electrodes.

FIG. 5 represents four identical pixels X(I,j) of a matrix 40 making it possible to mitigate this problem by means of shift registers U(i,j) integrated in each of the pixels X(i,j) and whose cells form the different storage locations. As previously, the invention is not limited to this number of pixels. Each pixel X(i,j) comprises three electronic switches, T1(i,j), T2(i,j) and T3(i,j). The switch T1(i,j) makes it possible to reset the potential of the sensitive element of the pixel, represented here by a photodiode K(i,j). The switch T1(i,j) is on at the start of the cycle of integration of a pixel X(i,j). After this start of the cycle, the switch T1(i,j) is off. The potential V of the node N(i,j) of the pixel X(i,j) then changes as a function of the lighting, according to a law ΔV=Q/C, ΔV being the potential variation at the node N(i,j), Q being the photocharge collected (that is to say the charge collected by virtue of the photon interactions in the detector) and C being the capacitance present at the integration node N(i,j), generally essentially due to the stray capacitance of the photodiode K(i,j). At the end of the integration cycle, the switch T3(i,j) is made to be on by the control electrode Phi-ligne(i). The assembly made up of the switch T2(i,j) and the current source Ipol(j) situated at the foot of the column electrode Col(j) then constitutes a follower state. A potential is thus obtained that is the image of that of the node N(i,j) at the foot of the column electrode Col(j) and used by a circuit S(j) making it possible, for example, to digitize the potential.

Each pixel X(i,j) also comprises a capacitor C(i,j) making it possible to modify the gain of the pixel X(i,j). A switch G(i,j) makes it possible to connect the capacitor C(i,j) to the node N(i,j) and thus increase the capacitance value present at the integration node N(i,j).

According to the invention, the grouping switches A(i,j) and B(i,j) and the storage means are again here formed by a shift register U(i,j) with three cells, each making it possible to control one of the switches A(i,j), B(i,j) and G(i,j).

The shift register U(i,j) comprises a clock input H(i,j) and a data input E(i,j) to which the data to be stored in the different cells of the shift register U(i,j) are conveyed in series. The data input E(i,j) is connected to a data electrode E-prog which can be common to all the pixels X(i,j) of the matrix 40, which is why no identifiers (i,j) are assigned to the data electrode E-prog. In FIG. 5, the electrode E-prog is routed on the lines i of the matrix 40. It is also possible to produce this routing by column or by grid.

The pixel X(i,j) that is to be programmed is chosen by means of its clock input H(i,j) and the data are presented in series to the data input E(i,j).

The clock input H(i,j) is formed by the output of an AND cell whose first input is connected to the row bus Phi-ligne(i) and whose second input is connected to a column electrode H-Col(j) making it possible to choose the column of pixels X(i,j) to be programmed. A particular pixel X(i,j) is selected by activating the row electrode Phi-ligne(i) concerned. The actual programming of the three cells of the shift register U(i,j) is performed by activating, three times, a command conveyed by the column electrode H-Col(j) in accordance with three programming values conveyed in series to the data input E(i,j).

Upon the acquisition of an image, all the commands conveyed by the column electrode H-Col(j) are deactivated and different pixels X(i,j) can be selected with the row electrode Phi-ligne(i), without disrupting the values programmed in the shift registers U(i,j).

In this example, the row electrode Phi-ligne(i) has been reused as electrode for selecting the pixels X(i,j) to be programmed. Alternatively, it is possible to implement a control electrode that is independent of the row electrode Phi-ligne(i) and dedicated to the programming of the different shift registers U(i,j).

As a variant, it is possible to produce an electrode E-prog specific to each row of the matrix. It is then possible, in programming mode, to activate all the commands borne by the row electrodes Phi-ligne(i) and simultaneously program all the pixels X(i,j) of one and the same column. This makes it possible to speed up the programming of the different shift registers U(i,j) of the matrix 40.

The programming of the different storage locations of a pixel requires only two specific electrodes: a clock electrode H-Col(j) and a data electrode proper E-prog, regardless of the number of storage locations. These two electrodes are connected to all the shift registers U(i,j) of the different pixels X(i,j). Thus, without adding to the number of buses of the matrix 40, it is possible to increase the number of storage locations for other needs of the pixel X(i,j).

The programming of the storage locations is done in a specific phase, preceding the imaging phase, the electrodes for addressing the pixels for the programming and those for reading can be partially or totally merged.

Advantageously, the storage means are configured to store a number of pixel grouping configurations and the device comprises means for choosing from the stored configurations. FIG. 6 represents an example of a pixel Y(i,j) in which the storage means are formed by a shift register V(i,j) comprising six cells making it possible to store two distinct control configurations for the different switches of the pixel Y(i,j), i.e. two configurations of three switches per pixel. More generally, the shift register V(i,j) contains several cells and the number of cells is equal to the number of storage locations multiplied by the number of distinct configurations that are to be stored.

In the example represented, the shift register V(i,j) operates in circular loopback mode by virtue of an additional control electrode Circ. The pixel Y(i,j) comprises three switches T1(i,j), T2(i,j) and T3(i,j) as well as an additional switch T4(i,j) driven by a control electrode Circ and making it possible to connect the data input E(i,j) either to the electrode E-prog or to the last cell of the shift register V(i,j). Two programming configurations can be stored, respectively in the first 3 and the last 3 cells of the shift register V(i,j). The programming of the shift register V(i,j) is done by driving the switch T4(i,j) so as to connect the data input E(i,j) to the electrode E-prog in accordance with six pulses applied to the clock input H(i,j). The transition from one configuration to the other is obtained by driving the switch T4(i,j) so as to connect the data input E(i,j) to the last cell of the shift register V(i,j) in accordance with three pulses applied to the clock input H(i,j). The clock pulses are obtained by activating the command present on the row electrode Phi-ligne(i) and by activating the command present on the electrode H-Col(j).

Obviously, the shift registers U(i,j) and V(i,j) can be implemented for any type of matrix, such as the matrices 10, 20 and 30 described previously.

The programming of the storage locations makes it possible to define any type of groupings: 2×2, 3×3, 4×4, . . . n×n, n×m, even groupings of complex forms, even groupings which are not identical over the entire dimension of the matrix with, for example, smaller groups at the center than at the edges of the matrix, or alternating small and large groups. The programming makes it possible to exclude the defective pixels from the groups.

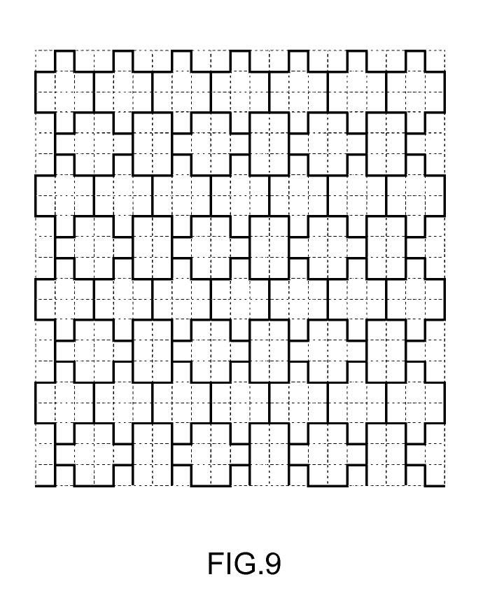

For examples of complex forms, FIG. 7 represents regular groupings in the form of cross-shaped groupings of eight pixels. The outlines of the pixels are shown by broken lines and the outlines of the groupings by solid lines. FIG. 8 represents regular groupings of three pixels organized in chevron form. FIG. 9 shows groupings of different sizes. Other forms of groupings are obviously possible.

It may be interesting to be able to rapidly switch from one grouping configuration to another. The programming of the storage locations makes it possible to rapidly redefine the groupings between two images or between successive sequences of images.

For example, if the pixels are grouped 2×2 in a dynamic imaging sequence, it may be interesting to move these groupings, from one image to the next, by one pixel to the right, then up, then to the left, then finally down, so that, after a cycle of 4 images, all the positions of these groupings have been implemented. A spatial resolution is thus recovered that is close to that which would have been obtained without the groupings while improving the signal-to-noise ratio of the image.

In the field of radiological imaging, the reconfiguration of the groupings of pixels also offers a benefit. For example, in fluoroscopy, it is possible to alternately use low-dose fluoroscopy modes and high-dose sequences. In the fluoroscopy mode, the aim is to read rapidly, and the spatial resolution is not sought. 2×2 groupings, even larger groupings, are therefore desirable. In the high-dose sequences, the image rate can be reduced, but the spatial resolution is sought and the size of the groupings is reduced. It is even possible to not group any pixel and read them all separately.

With the structures previously described in the matrices 10, 20 and 30, it is necessary to completely reprogram the storage locations concerned via the grouping switches A(i,j) and B(i,j), and do so for all the pixels of the matrix. The programming time can be significant.

Advantageously, to reduce the programming time, the storage means M(i,j) are configured to store several pixel grouping configurations. The device then comprises means for choosing from the stored configurations.

When a shift register is implemented, it is possible to multiply the number of cells by the number of distinct configurations that are to be stored. For example, in the matrices 10 and 20 represented in FIGS. 1 and 2, if the aim is to store two pixel grouping configurations, a shift register is provided comprising four cells, and six cells in the matrix 30.

For the matrices 10 and 20 and two configurations, in a first phase, a programming phase, the four cells are filled from the serial input of the register, the first two cells corresponding to the first configuration and the last two cells corresponding to the second. This applies for all the pixels of the matrix.

Then, the shift registers of all the pixels are reconfigured to operate in loop mode.

When there is a desire to switch from one grouping configuration to the other, it is then sufficient to send two clock pulses, simultaneously, to all the registers of the matrix, which can be very fast.

1. An imaging device comprising a matrix of pixels organized in rows and columns, each current pixel of the matrix comprising:
a row grouping switch making it possible to group the current pixel with the following pixel; of the same row, if the following pixel exists, in the row to which the current pixel belongs,
a column grouping switch making it possible to group the current pixel with the following pixel of the same column, if the following pixel exists, in the column to which the current pixel belongs, and
storage means making it possible to define the state, on or off, of the two grouping switches.

2. The device as claimed in claim 1, wherein the pixels are all identical.

3. The device as claimed in claim 1, the storage means comprising two binary storage locations in each of which the state of one of the switches and is stored.

4. The device as claimed in claim 1, each current pixel also comprising an actuator for reading the current pixel, and wherein the storage means of the current pixel make it possible to authorize the closure of the actuator for reading the current pixel in conjunction with a command to read the current pixel.

5. The device as claimed in claim 3, the storage means comprising an additional binary storage location, in which an authorization to close the actuator is stored.

6. The device as claimed in claim 3, wherein the storage locations are addressed by means of row and column electrodes making it possible to identify the pixel addressed and wherein the device comprises a data electrode for each storage location and common to all the pixels.

7. The device as claimed in claim 3, wherein the storage locations are addressed by means of row and column electrodes making it possible to identify the pixel addressed, wherein each pixel comprises a shift register forming the storage means, and wherein the device comprises a clock electrode and a data electrode (E-prog) connected to all the shift registers of the different pixels.

8. The device as claimed in claim 1, wherein the storage means are configured to store a number of grouping configurations of pixels and wherein the device comprises means for choosing from the stored configurations.

9. The device as claimed in claim 7, the shift register containing a number of cells and wherein the number of cells is equal to the number of storage locations multiplied by the number of distinct configurations that are to be stored.

10. A method implementing the imaging device as claimed in claim 1, comprising an imaging phase, carrying out a phase of programming the storage means of the pixels before the imaging phase.
